(19) United States
(12) Patent Application Publication
(10) Pub. No.: US 2026/0250015 A1
(43) Pub. Date: Aug. 27, 2026

(54) METHOD AND AVIONICS DEVICE FOR CONTROLLING THE PITCH ANGLE OF A FAN OR PROPELLER OF AN AIRCRAFT POWERTRAIN

(71) Applicant: AIRBUS OPERATIONS SAS, Toulouse (FR)

(72) Inventors: Luc BRUNEL, Toulouse (FR); David BOYER, Toulouse (FR); Quentin-Alexandre FLAMANT-BATI, Toulouse (FR); Nicolas PILON, Toulouse (FR); Carlo NECCI, Toulouse (FR); Laetitia MARRAST, Toulouse (FR)

(73) Assignee: AIRBUS OPERATIONS SAS, Toulouse (FR)

(21) Appl. No.: 19/540,289

(22) Filed: Feb. 13, 2026

(30) Foreign Application Priority Data
Feb. 27, 2025 (FR) 2501991

(51) Int. Cl. B64D 45/00; B64C 11/30; B64C 13/16

(52) U.S. Cl. CPC B64D 45/00; B64C 11/301; B64C 13/16

(57) ABSTRACT

A method for controlling a pitch angle of a fan or propeller of an aircraft powertrain with the intention of feathering said fan or propeller when an inconsistency of said pitch angle is detected. The invention furthermore relates to an avionics device configured to implement the method. Advantageously, it is thus possible to limit the risks of undesirable aerodynamic effects in the event of malfunctioning of the pitch angle control.

### TECHNICAL FIELD

The present invention relates to a method and device for checking the consistency of a pitch angle of the blades of a fan or propeller of an aircraft powertrain, and for controlling the pitch angle of the blades of the powertrain if a pitch angle defect is detected.

### PRIOR ART

Aircraft powertrains comprise fans or propellers having a variable pitch, thereby making it possible to control the thrust developed by a powertrain by acting on the pitch angle of the blades. Each aircraft powertrain is controlled by its own control device, said control device being connected to an avionics control device, for example an IMA (integrated modular avionic) computer implementing functions related to the propulsion of the aircraft on board which it is housed. The control device for controlling the powertrain regulates the thrust generated by the powertrain based on commands received from the avionics control device, and in particular controls the pitch angle of the blades of the fan or propeller.

Some fan or propeller blade configurations are not acceptable under certain flight conditions, due to the altitude and speed of movement of the aircraft in question, as they may cause undesirable aerodynamic effects for the flight of the aircraft. A pitch angle may thus become too small to guarantee good flight conditions for the aircraft, for certain combinations of altitude and speed. This may be the case in the event of malfunctioning of the control system for controlling the pitch angle of the blades of a fan or propeller.

The situation could be improved.

### SUMMARY OF THE INVENTION

One subject of the present invention is to propose a method for controlling a pitch angle of the blades of a fan or propeller of a powertrain of an aircraft, the method being carried out in an avionics device of the aircraft, the avionics device being housed on board the aircraft, independent of the powertrain and connected to a control device for controlling the powertrain driving the fan or propeller, the control device being contained within the powertrain, the method comprising:
obtaining first information representative of flight conditions of the aircraft, in relation to its external environment, supplied by at least one avionics computer of the aircraft independent of the powertrain, this first information comprising at least an altitude and an airspeed of the aircraft,
the method being such that it furthermore comprises:
determining a threshold value for the pitch angle of the blades of the fan or propeller, based on the first information, so as to limit the risks of undesirable aerodynamic effects for the flight of the aircraft when the aircraft is flying at said altitude with said airspeed,
obtaining information representative of a current pitch angle of the blades of the fan or propeller, and then
sending a control command for the powertrain when the information representative of the current pitch angle is less than the threshold value, the control command being intended to feather the fan or propeller of the powertrain of the aircraft.

It is thus possible to limit the risks of undesirable aerodynamic effects for the flight of the aircraft in the event of malfunctioning of the pitch angle control. The method is all the more advantageous when the feathering command is implemented by the avionics device, independently of the powertrain and its control device, on the basis of said information representative of flight conditions of the aircraft in relation to its external environment.

According to one embodiment, the control command for the powertrain is a control signal sent to the control device for controlling the powertrain, so as to feather the fan or propeller under the control of the control device for controlling the powertrain.

According to one embodiment, the control command for the powertrain is a control signal for controlling the cutoff of the supply of fuel to the powertrain, sent with a view to ordering the closure of a valve connected in series on a fuel supply line for supplying fuel to the powertrain, or a control signal for controlling the cutoff of the supply of power to the control device for controlling the powertrain, sent with a view to ordering the opening of an electrical contactor connected in series on a power supply line for supplying power to the control device for controlling the powertrain.

According to one embodiment, the avionics device being connected to control devices for controlling at least two powertrains of the aircraft, the avionics device is configured to supervise the control of the pitch angle of the blades of fans or propellers of said at least two powertrains and not to simultaneously order feathering of the fans or propellers of all powertrains of the aircraft.

Another subject of the invention is an avionics control device for controlling a pitch angle of the blades of a fan or propeller of a powertrain of an aircraft, the avionics control device being designed to be housed on board the aircraft, independent of the powertrain and comprising electronic circuitry configured to:
obtain first information representative of flight conditions of the aircraft in relation to its external environment, supplied by at least one avionics computer of the aircraft independent of the powertrain, this first information comprising at least an altitude and an airspeed of the aircraft,
the electronic circuitry of the avionics control device for controlling a pitch angle is furthermore configured to:
determine a threshold value for the pitch angle of the blades of the fan or propeller, based on the first information, so as to limit the risks of undesirable aerodynamic effects for the flight of the aircraft when the aircraft is flying at said altitude with said airspeed,
obtain information representative of a current pitch angle of the blades of the fan or propeller, and then
send a control command for the powertrain when the information representative of the current pitch angle is less than the threshold value, the control command being intended to feather the fan or propeller of the powertrain of the aircraft.

According to one embodiment, the electronic circuitry of the avionics control device for controlling a pitch angle is furthermore configured to send the control command for the powertrain in the form of a control signal sent to a control device for controlling the powertrain, contained within the powertrain, so as to feather the fan or propeller of the aircraft powertrain under the control of the control device for controlling the powertrain.

According to one embodiment, the electronic circuitry of the avionics control device for controlling a pitch angle is furthermore configured to send the control command for the powertrain in the form of a control signal for controlling the cutoff of the supply of fuel to the powertrain, sent with a view to ordering the closure of a valve connected in series on a fuel supply line for supplying fuel to the powertrain, or a signal for cutting off the supply of power to the control device for controlling the powertrain, sent with a view to ordering the opening of an electrical contactor connected in series on a power supply line for supplying power to the control device for controlling the powertrain.

According to one embodiment, the electronic circuitry of the avionics control device for controlling a pitch angle is configured to supervise the control of the pitch angle of the blades of fans or propellers of at least two powertrains of the aircraft and not to simultaneously order feathering of the fans or propellers of all powertrains of the aircraft.

Another subject of the invention is an aircraft comprising an avionics control device for controlling a pitch angle as described above.

The invention additionally relates to a computer program product comprising program code instructions for executing the steps of a method as described above when this program is executed by a processor of an avionics device, and also a storage medium comprising a computer program product as mentioned above.

### BRIEF DESCRIPTION OF THE DRAWINGS

FIG. 1 schematically illustrates a control system for controlling the pitch angle of the blades of an aircraft fan according to one embodiment;

FIG. 2 is a flowchart illustrating steps of a method for controlling the pitch angle of the blades of an aircraft fan according to one embodiment;

FIG. 3 illustrates an aircraft comprising an avionics device according to one embodiment; and

FIG. 4 illustrates one example of an internal architecture of an avionics device configured to carry out the method illustrated in FIG. 2.

### DETAILED DESCRIPTION OF EMBODIMENTS

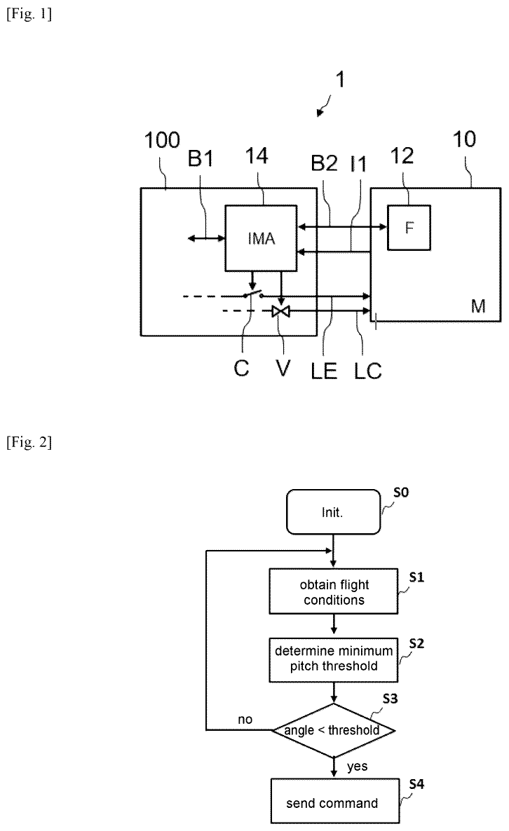

FIG. 1 schematically shows a control system 1 for controlling the pitch angle of the blades of a fan of a powertrain M 10 of an aircraft 100. The control system 1 is installed on board the aircraft 100. The control system 1 comprises an avionics control device 14. The control system 1 and the avionics control device 14 are independent of the powertrain 10. According to one embodiment, the powertrain 10 is a turbojet-engine powertrain that comprises a fan. As is known, the powertrain 10 is mounted so as to be integral with the aircraft 100. The powertrain 10 comprises a control device F 12 dedicated to a set of control functions for the powertrain 10, and referred to herein as the “control device for controlling the powertrain”. According to one embodiment, the control device 12 for controlling the powertrain 10 is a FADEC (full authority digital engine control) device. The avionics control device 14 is connected to the control device 12 for controlling the powertrain.

The control device 12 for controlling the powertrain is configured, among the set of control functions for the powertrain 10, to control the pitch angle of the blades of the fan of the powertrain 10. The pitch angle here is an angle of orientation of the blades of the fan with respect to the plane of rotation of the fan, said plane being perpendicular to the axis of rotation of the fan. More specifically, the pitch angle of the blades of the fan is an angle between a reference chord of the profile of the blades of the fan and the plane of rotation of the fan. According to one embodiment, the reference chord may be the chord of the profile of a blade at the centre thereof (at the centre of the length of the blade). According to some variants, the reference chord is the chord of the blade profile at another point of the blades. The control device 12 for controlling the powertrain 10 is for its part controlled and supervised by the avionics control device 14, for example IMA device. For this purpose, the control device 12 for controlling the powertrain is connected to the avionics control device 14 via a set of connections carrying unidirectional and bidirectional signals, considered globally here to be a communication bus B2. The avionics control device 14 is for its part connected to third-party systems of the aircraft, comprising for example sensors, actuators and modules for controlling and piloting the aircraft, such as avionics computers of the aircraft, via a communication bus B1, which comprises (or carries) a large number of unidirectional and bidirectional signals. Said sensors, actuators and modules for controlling and piloting the aircraft are independent of the powertrain 10. Said modules for controlling and piloting the aircraft, such as avionics computers of the aircraft, are configured in particular to acquire information from said sensors and to determine accordingly information representative of flight conditions of the aircraft in relation to its external environment.

In addition, the control device 12 for controlling the powertrain 10 is supplied with power by at least one power supply line LE from the aircraft 100. The powertrain 10 is supplied with fuel by at least one fuel supply line LC from the aircraft 100.

According to one embodiment, the powertrain 10 is configured to deliver, to the avionics control device 14, a signal I1 representative of the current pitch angle of the blades of the fan of the powertrain 10. According to a first alternative, the signal I1 comes from the control device 12 for controlling the powertrain. According to another alternative, the signal I1 comes directly from a sensor delivering a signal representative of the pitch angle of the blades of the fan.

FIG. 2 is a flowchart illustrating a method for controlling the pitch angle of the blades of the fan of the powertrain 10 according to one embodiment of the invention. A first step S0 is an initialization step at the end of which all circuits, devices and systems of the aircraft useful for the operation of the aircraft are supplied with power, initialized and configured to carry out a flight of the aircraft housing on board the control system 1 for controlling the pitch angle of the blades of a fan. In a step S1, with the aircraft travelling in a take-off, climb, cruise or descent phase, or even in a landing phase, the avionics control device 14 regularly and iteratively receives a plurality of items of information representative of flight conditions of the aircraft in relation to its external environment. According to one embodiment, these items of information representative of flight conditions of the aircraft in relation to its external environment comprise the current airspeed of the aircraft, the current ground speed of the aircraft, the current altitude of the aircraft with respect to a reference level (for example sea level), the current air temperature, the current atmospheric pressure at sea level, the current local atmospheric pressure, the current wind force and direction, the current hygrometry, etc. These examples are not limiting. In a step S2, the avionics control device 14 determines, based on at least a speed of the aircraft and an altitude of the aircraft, a threshold value representative of a minimum pitch angle below which the blades of the fan must not be configured and below which it will then be necessary to feather the blades of the fan, that is to say configure them at an angle resulting in minimum aerodynamic drag or in a reference position of the blades that is considered to be a feathered configuration of the fan. This minimum pitch angle is determined so as to limit the risks of undesirable aerodynamic effects for the flight of the aircraft when the aircraft is flying at said altitude with said airspeed, the blades of the fan being configured with this minimum pitch angle. According to one embodiment, this threshold value for the pitch angle of the blades of the fan of the powertrain M 10 is determined based on one or more tables recorded in a memory accessible from the avionics control device 14. According to one embodiment, these one or more tables are stored in a non-volatile memory internal to the avionics control device 14 or connected to this device, for example by way of the bus B1. These one or more tables are for example established based on in-flight tests on an aircraft similar to the aircraft 100.

In a step S3, the signal I1 from the powertrain 10 is compared with the threshold value determined in step S2 such that, if the current pitch angle of the blades of the fan is less than the threshold value, a control signal is sent by the avionics device 14, in a step S4, to feather the blades of the fan.

Of course, when the current pitch angle is not less than the threshold value, the avionics control device 14 does not send such a control signal, and therefore the control device 12 for controlling the powertrain 10 continues to control the pitch angle of the blades of the fan in the usual way, and the method loops back to step S1.

According to one embodiment, the control signal sent by the avionics control device is addressed to the control device 12 for controlling the powertrain 10, for example on the bus B2. The blades of the fan are then feathered by the control device 12 for controlling the powertrain 10, following the receipt of said control signal sent by the avionics device 14. The details of the feathering of the blades of the fan under the control of the control device 12 for controlling the powertrain 10 are not expanded on here because they are not needed to understand the invention. Those skilled in the art will know how to use known means for feathering the blades of a fan.

According to some variant embodiments, the control signal sent by the avionics device 14 when the current pitch angle of the blades of the fan drops below the determined threshold value is a control command capable of interrupting the supply of fuel to the powertrain 10 or capable of cutting off all or part of the supply of power to the control device 12 for controlling the powertrain 10, this having the effect of causing feathering of the blades of the fan. For example, the control command has the effect of ordering the opening of an electrical contactor C connected in series, on board the aircraft 100, on the power supply line LE for supplying power to the control device 12 for controlling the powertrain 10. Again for example, the control command has the effect of ordering the closure of a valve V connected in series, on board the aircraft 100, on the fuel supply line LC for supplying fuel to the powertrain 10.

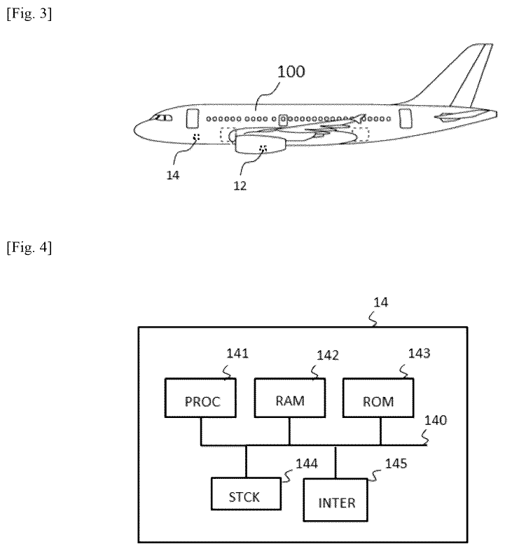

FIG. 3 schematically illustrates an aircraft 100 comprising the avionics device 14 that advantageously makes it possible to safeguard the operations of controlling the pitch angle of the blades of the fan of a powertrain 10 in order to avoid any configuration prejudicial to the flight of the aircraft 100, for example any configuration capable of causing undesirable aerodynamic conditions for the flight of the aircraft. The powertrain 10 comprises the control device 12 for controlling the powertrain.

According to one embodiment, the avionics device 14 is configured to supervise the control of the pitch angle of the blades of a plurality of powertrain fans (and therefore of a plurality of powertrains). Such control of multiple powertrains may advantageously be carried out according to predetermined strategies. For example, one predetermined strategy is such that it is not possible to simultaneously feather all fans of the powertrains of one and the same aircraft, this being tantamount to saying that at least one of them must remain operational with a pitch angle configured to provide minimum thrust (pitch angle controlled in the usual way by the control device 12 for controlling the powertrain corresponding to this fan).

FIG. 4 schematically illustrates one example of an internal architecture of the avionics control device 14 for controlling the pitch angle of the blades of a fan of the aircraft 100.

According to the exemplary hardware architecture shown in FIG. 4, the avionics control device 14 for controlling a pitch angle then comprises the following, connected by a communication bus 140: a processor or central processing unit (CPU) 141; a random access memory (RAM) 142; a read-only memory (ROM) 143; a storage unit such as a hard disk (or a storage medium reader, such as a Secure Digital (SD) card reader) 144; a power and communication interface module 145 allowing the avionics control device 14 for controlling a pitch angle to communicate with remote devices, such as remote sensors, actuators or controllers (for example hydraulic or pneumatic valves, electrical contactors, etc.), including in particular one or more controller devices for controlling an aircraft powertrain.

The processor 141 of the avionics control device for controlling a pitch angle is capable of executing instructions loaded into the RAM 142 from the ROM 143, from an external memory (not shown), from a storage medium (such as an SD card), or from a communication network. When the avionics control device 14 for controlling a pitch angle is powered on, the processor 141 is capable of reading instructions from the RAM 142 and of executing them. These instructions form a computer program that causes the processor 141 of the avionics control device for controlling a pitch angle to implement all or part of a method for controlling the pitch angle of the blades of a fan or propeller, in particular based on obtained information representative of a current pitch angle and flight conditions of the aircraft in question in relation to its external environment.

All or part of such a method for controlling the pitch angle of the blades of a fan or propeller, as illustrated with reference to FIG. 2, may then be implemented in software form via execution of a set of instructions by a programmable machine, for example a digital signal processor (DSP) or a microcontroller, or be implemented in hardware form by a dedicated machine or component, for example a field-programmable gate array (FPGA) or an application-specific integrated circuit (ASIC). In general, the avionics control device 14 for controlling a pitch angle of the blades of a fan or propeller comprises electronic circuitry configured to implement a method for controlling a pitch angle as described. Of course, the avionics control device 14 for controlling a pitch angle of the blades of a fan or propeller furthermore comprises or is coupled to all of the elements usually present in an electronic system comprising a control unit and its peripherals, such as a power supply circuit, a power supply monitoring circuit, one or more clock circuits, a zeroing circuit, input/output ports, interrupt inputs, and bus drivers, this list not being exhaustive.

The control of the pitch angle of the blades of a fan described above applies in the same way to blades of a propeller of an aircraft-propeller powertrain, in particular a turboprop.

1. A method for controlling a pitch angle of the blades of a fan or propeller of a powertrain of an aircraft, the method being carried out in an avionics device of said aircraft, the avionics device being housed on board the aircraft, independent of the powertrain and connected to a control device for controlling said powertrain driving said fan or said propeller, the control device being contained within the powertrain, the method comprising:
obtaining first information representative of flight conditions of said aircraft in relation to its external environment, supplied by at least one avionics computer of the aircraft independent of the powertrain, this first information comprising at least an altitude and an airspeed of the aircraft,
determining a threshold value for the pitch angle of the blades of said fan or propeller, based on said first information, so as to limit the risks of undesirable aerodynamic effects for the flight of the aircraft when the aircraft is flying at said altitude with said airspeed,
obtaining information representative of a current pitch angle of the blades of said fan or propeller, and
sending a control command for said powertrain when said information representative of said current pitch angle is less than said threshold value, said control command being intended to feather said fan or propeller of said powertrain of the aircraft.

2. The control method according to claim 1, wherein said control command for said powertrain is a control signal sent to said control device for controlling the powertrain, so as to feather said fan or propeller under the control of the control device for controlling the powertrain.

3. The control method according to claim 1, wherein said control command for said powertrain is a control signal for controlling the cutoff of the supply of fuel to said powertrain, sent with a view to ordering the closure of a valve connected in series on a fuel supply line for supplying fuel to said powertrain, or a control signal for controlling the cutoff of the supply of power to said control device for controlling the powertrain, sent with a view to ordering the opening of an electrical contactor connected in series on a power supply line for supplying power to said control device for controlling the powertrain.

4. The method for controlling a pitch angle of the blades of a fan or propeller according to claim 1, wherein, the avionics device being connected to control devices for controlling at least two powertrains of the aircraft, the avionics device is configured to supervise the control of the pitch angle of the blades of fans or propellers of said at least two powertrains and not to simultaneously order feathering of the fans or propellers of all powertrains of the aircraft.

5. An avionics control device for controlling a pitch angle of the blades of a fan or propeller of a powertrain of an aircraft, said avionics control device being designed to be housed on board the aircraft, independent of the powertrain and comprising:
electronic circuitry configured to:
obtain first information representative of flight conditions of said aircraft in relation to its external environment, supplied by at least one avionics computer of the aircraft independent of the powertrain, this first information comprising at least an altitude and an airspeed of the aircraft,
determine a threshold value for the pitch angle of the blades of said fan or propeller, based on said first information, so as to limit the risks of undesirable aerodynamic effects for the flight of the aircraft when the aircraft is flying at said altitude with said airspeed, and
obtain information representative of a current pitch angle of the blades of said fan or propeller, and then
send a control command for said powertrain when said information representative of said current pitch angle is less than said threshold value, said control command being intended to feather said fan or propeller of said powertrain of the aircraft.

6. The avionics control device according to claim 5, wherein the electronic circuitry is furthermore configured to send said control command for said powertrain in the form of a control signal sent to a control device for controlling the powertrain, contained within the powertrain, so as to feather said fan or propeller of said aircraft powertrain under the control of the control device for controlling the powertrain.

7. The avionics control device according to claim 5, wherein the electronic circuitry is furthermore configured to send said control command for said powertrain in the form of a control signal for controlling the cutoff of the supply of fuel to said powertrain, sent with a view to ordering the closure of a valve connected in series on a fuel supply line for supplying fuel to said powertrain, or a signal for cutting off the supply of power to said control device for controlling the powertrain, sent with a view to ordering the opening of an electrical contactor connected in series on a power supply line for supplying power to said control device for controlling the powertrain.

8. The avionics control device for controlling a pitch angle of the blades of a fan or propeller according to claim 5, wherein the electronic circuitry is configured to supervise the control of the pitch angle of the blades of fans or propellers of at least two powertrains of the aircraft and not to simultaneously order feathering of the fans or propellers of all powertrains of the aircraft.

9. An aircraft comprising an avionics control device for controlling a pitch angle according to claim 5.

10. (canceled)

11. A non-transitory storage medium comprising a computer program product comprising program code instructions for executing the steps of the control method according to claim 1 when the computer program product is executed by a processor of an avionics device.
